(19) United States
(12) Patent Application Publication
(10) Pub. No.: US 2009/0324288 A1
(43) Pub. Date: Dec. 31, 2009

(54) Photoreceptor and Image Forming Apparatus Including the Same

(75) Inventors: Yoshinobu ISHII, Higashiomi (JP); Takashi NAKAMURA, Higashiomi (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi (JP)

(21) Appl. No.: 12/491,077

(22) Filed: Jun. 24, 2009

(30) Foreign Application Priority Data
Jun. 25, 2008 (JP) 2008-165754

(51) Int. Cl. G03G 15/00

(52) U.S. Cl. 399/159

(57) ABSTRACT

According to an embodiment of the invention, a photoreceptor comprises a conductive substrate; a first semiconductor layer over the conductive substrate; a second semiconductor layer over the first semiconductor layer; and a third semiconductor layer over the second semiconductor layer. Each of the first and the third semiconductor layers comprises a p-type semiconductor. The second semiconductor layer has a hole density smaller than the first and the third semiconductor layers.

### CROSS REFERENCE TO RELATED APPLICATION(S)

The present application claims priority under 35 U.S.C. §119 to Japanese Patent Application No. 2008-165754, filed Jun. 25, 2008, entitled “PHOTORECEPTOR AND IMAGE FORMING APPARATUS INCLUDING THE SAME” the entirety of which is incorporated by reference herein.

### BACKGROUND OF THE INVENTION

1. Field of the Invention

The present invention relates to a photoreceptor and an image forming apparatus including the same.

2. Description of the Related Art

An electrophotographic image forming apparatus includes an electrophotographic photoreceptor prepared by forming layers including a photosensitive layer on the periphery of, for example, an aluminum cylindrical substrate. Such a photoreceptor may be a negative charge photoreceptor having a negative surface charge. The negative charge photoreceptor generally has a plurality of layers including a lower charge injection blocking layer, a photoconductive layer, an upper charge injection blocking layer and a surface layer in that order on the cylindrical substrate. In general, the negative charge photoreceptor has the lower charge injection blocking layer with no doped impurities such as, for example, a Group 13 element or a Group 15 element (as disclosed in, for example, Japanese Unexamined Patent Application Publication Nos. 2003-15335 and 2003-15337) to enhance the ability of blocking charge injection (as disclosed in, for example, Japanese Unexamined Patent Application Publication No. 2003-107765).

Such a photoreceptor has a multilayer structure that allows electrons to move easily from the surface of the substrate to the surface of the photosensitive layer through the photosensitive layer when a positive charge is applied to the surface of the photoreceptor, for example, at transferring. When a relatively high positive charge is applied to the surface of the photoreceptor, a large amount of electrons move in a short time because of relatively high mobility of the electrons, and may cause a leakage current.

Accordingly, an object of the present invention is to provide a photoreceptor having a high withstand voltage against positive charge, and an image forming apparatus including the same.

### SUMMARY OF THE INVENTION

According to an embodiment of the invention, a photoreceptor comprises a conductive substrate; a first semiconductor layer over the conductive substrate; a second semiconductor layer over the first semiconductor layer; and a third semiconductor layer over the second semiconductor layer. Each of the first and the third semiconductor layers comprises a p-type semiconductor. The second semiconductor layer has a hole density smaller than the first and the third semiconductor layers.

According to another embodiment of the invention, an image forming apparatus comprises the above photoreceptor; and a charger for electrically-negatively charging a surface of the photoreceptor. The image forming apparatus also comprises an exposing device for illuminating the charged surface of the photoreceptor to form an electrostatic latent image on the surface of the photoreceptor. The image forming apparatus further comprises a developing device for supplying a toner onto the surface of the photoreceptor to form on a toner image corresponding to the electrostatic latent image thereon; and a transferring device for electrically-positively charging a medium to be supplied to the surface of the electrographic photoreceptor, and transferring the toner image to the medium.

The above photoreceptor can exhibit a relatively low leakage current when, for example, a positive charge is applied to the surface of the photoreceptor.

### BRIEF DESCRIPTION OF THE DRAWINGS

FIG. 1 is a schematic sectional view of an image forming apparatus according to an embodiment of the present invention;

FIG. 2 is a partially enlarged schematic sectional view of a negative charge electrophotographic image forming apparatus according to an embodiment of the present invention;

FIG. 3 is a sectional view of a plasma CVD apparatus for forming a photosensitive layer of the electrophotographic photoreceptor shown in FIG. 2;

FIG. 4 is a graph showing voltages applied to the plasma CVD apparatus shown in FIG. 3; and

FIG. 5 is a partially enlarged schematic sectional view of a negative charge electrophotographic image forming apparatus according to another embodiment of the present invention.

### DESCRIPTION OF THE PREFERRED EMBODIMENTS

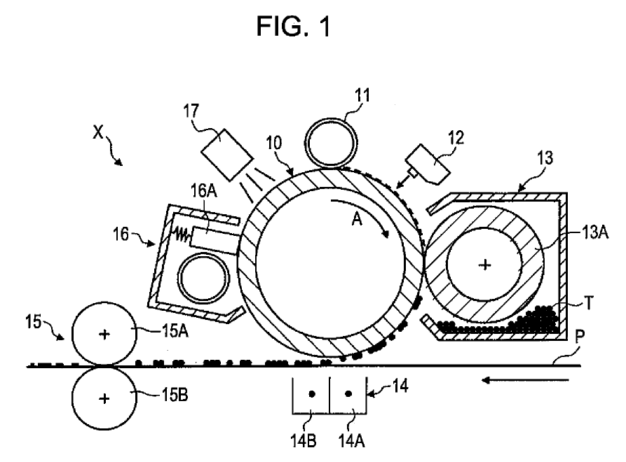

FIG. 1 is a schematic sectional view of an image forming apparatus X according to an embodiment of the present invention. The image forming apparatus X forms images by Carlson process, and includes an electrophotographic photoreceptor 10, a charger 11, an exposing device 12, a developing device 13, a transferring device 14, a fuser 15, a cleaner 16, and a charge eliminating device 1.

The charger 11 negatively charges the surface of the electrophotographic photoreceptor 10. The charged voltage may be in the range of, for example, 200 to 1000 V. The charger 11 used in the present embodiment may be of contact type including a core coated with, for example, an electroconductive rubber film and a PVDF (polyvinylidene fluoride) film. The charger 11 may be of non-contact type including a discharge wire, such as a corona charger.

The exposing device 12 irradiates the electrophotographic photoreceptor 10 with exposing light according to the image signal, thus the potential of the portion exposed to the exposing light of the charged electrophotographic photoreceptor 10 is reduced to form an electrostatic latent image. The exposing device 12 may be, for example, an LED head including a plurality of LEDs which are operable to emit light. A wavelength of the light emitted from the exposing device 12 is preferably in a range of 650 nm to 780 nm.

The exposing device 12 may be another type including a light source emitting laser light instead of LEDs. In other words, as an alternative to an LED head or the like, the exposing device 12 may be an optical system including a polygon mirror or including a lens transmitting light reflected from a source document and a mirror.

The developing device 13 develops the electrostatic latent image of the electrophotographic photoreceptor 10 to form a toner image. The developing device 13 used in the present embodiment includes a magnetic roller 13A magnetically holding a developer T which is, for example, toner.

The developer T is frictionally charged in the developing device 13. The developer T may be a two-component type containing a magnetic carrier and an insulating toner or a monocomponent type containing a magnetic toner.

The magnetic roller 13A carries the developer to a developing region in the surface of the electrophotographic photoreceptor 10. The magnetic roller 13A in the developing device 13 carries the frictionally charged developer T. The carried developer T is attached to the developing region in the surface of the photoreceptor by an electrostatic attraction of the electrostatic latent image to form a toner image, that is, to visualize the electrostatic latent image. The toner image is charged with a polarity opposite to the polarity of the surface of the electrophotographic photoreceptor 10 for image forming by a normal developing process. For image forming by reversal developing process, the toner image is charged with the same polarity as the surface of the electrophotographic photoreceptor 10. In the present embodiment, images are formed by reversal developing process. More specifically, the toner image is charged with the same polarity as the surface of the electrophotographic photoreceptor 10, that is, negative polarity.

Although the developing device 13 of the present embodiment performs development in a dry process, a wet process using a liquid developer may be employed.

The transferring device 14 transfers the toner image on the electrophotographic photoreceptor 10 to a recording medium P supplied to a transfer region between the electrophotographic photoreceptor 10 and the transferring device 14. The transferring device 14 used in the present embodiment includes a transfer charger 14A and a separation charger 14B. In the transferring device 14, the rear surface (non-recording surface) of the recording medium P is charged with a polarity opposite to the polarity of the toner image by the transfer charger 14A, and the toner image is transferred onto the recording medium P by electrostatic attraction produced between the recording medium P and the toner image. Also, the rear surface of the recording medium P is AC-charged by the separation charger 14B, so that the recording medium P separates immediately from the surface of the electrophotographic photoreceptor 1.

The transferring device 14 may include a transfer roller driven by the rotation of the electrophotographic photoreceptor 10, disposed with a small gap (generally 0.5 mm or less) from the electrophotographic photoreceptor 10. A direct-current power supply applies a transfer voltage to the transfer roller for drawing the toner image on the electrophotographic photoreceptor 10 to the recording medium P. If such a transfer roller is used, the separation charger 14B may be omitted.

The fuser 15 fixes the toner image transferred to the recording medium P and includes a pair of fuser rollers 15A and 15B. The fuser rollers 15A and 15B each may include a metal roller coated with a fluorocarbon polymer. In the fuser 15, a toner image is fixed to a recording medium P passing between the fuser rollers 15A and 15B by applying heat or pressure.

The cleaner 16 removes the toner remaining on the surface of the electrophotographic photoreceptor 10, and includes a cleaning blade 16A. The cleaning blade 16A scrapes the residual toner from the surface of the electrophotographic photoreceptor 10. The cleaning blade 16A may comprise, for example, a rubber mainly containing, for example, polyurethane resin.

The charge eliminating device 17 removes the surface charge of the electrophotographic photoreceptor 10. The charge eliminating device 17 can emit light having a specific wavelength (for example, 780 nm or more). For example, the charge eliminating device 17 includes a light source, such as an LED, and the light source irradiates the surface of the electrophotographic photoreceptor 10 entirely in the axis direction of the surface, thereby removing the surface charge (residual electrostatic latent image) of the electrophotographic photoreceptor 10.

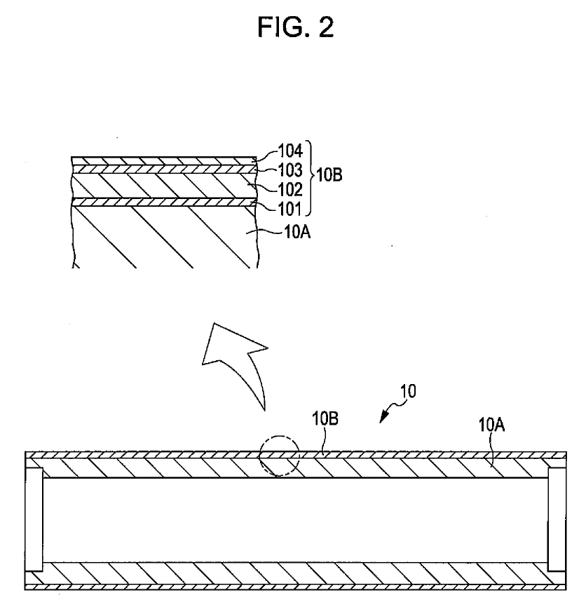

FIG. 2 is a schematic sectional view of the electrophotographic photoreceptor 10. The electrophotographic photoreceptor 10 includes a substrate 10A and a photosensitive layer 10B on the periphery of the substrate 10A, and an electrostatic latent image and a toner image are formed on the electrophotographic photoreceptor 10 according to the image signal. The electrophotographic photoreceptor 10 can be rotated in the direction indicated by arrow A in FIG. 1 by a rotation mechanism (not shown).

The substrate 10A acts as the support base for the photosensitive layer 10B. The substrate 10A comprises a surface which is electrically conductive. Although the substrate 10A in the present embodiment is a cylindrical substrate, the substrate 10A may be an endless belt. The substrate 10A may comprise a metal or an alloy containing the metal so that the entirety of the substrate 10A is electrically conductive, or may include an insulating member and an electroconductive layer on the insulating member. An insulating material for the insulating member may comprise a synthetic resin, glass and/or ceramic. The conductive material for the electroconductive layer may comprise a metal or a transparent electroconductive material. Metals that can be used as the material of the substrate 10A include aluminum (Al), stainless steel (SUS), zinc (Zn), copper (Cu), iron (Fe), titanium (Ti), nickel (Ni), chromium (Cr), molybdenum (Mo), indium (In), niobium (Nb), tellurium (Te), vanadium (V), palladium (Pd), tantalum (Ta), tin (Sn), platinum (Pt), gold (Au) and silver (Ag). Synthetic resins include polyester, polyethylene, polycarbonate, cellulose acetate, polypropylene, polyvinyl chloride, polystyrene and polyamide. Transparent electroconductive materials include ITO (Indium Tin Oxide) and SnO₂. Preferably, at least the surface of the substrate 10A contains an Al alloy, such as Al—Mn alloy, Al—Mg alloy or Al—Mg—Si alloy, from the viewpoint of enhancing the adhesion with the photosensitive layer 10B that may include an amorphous silicon (a-Si)-based material.

The surface of the substrate 10A is formed is surface-treated. For example, the surface of the substrate 10A may be subjected to mirror finishing or linear grooving by using, for example, a lathe.

The photosensitive layer 10B has a thickness in the range of, for example, 15 to 90 μm. If the thickness of the photosensitive layer 10B is 15 μm or more, an interference pattern in the recorded image can be relatively favorably reduced. A photosensitive layer 10B having a thickness of 90 μm or less can be favorably more attached to the substrate 10A.

The photosensitive layer 10B used in the present embodiment has a multilayer structure including a first semiconductor layer 101, a second semiconductor layer 102, a third semiconductor layer 103 and a surface layer 104. In the electrophotographic photoreceptor 10 of the present embodiment, the first semiconductor layer 101 and the third semiconductor layer 103 comprises a p-type semiconductor, and the second semiconductor layer 102 has a smaller hole density than the first semiconductor layer 101 and the third semiconductor layer 103. Hence, the activation energy of the first semiconductor layer 101 is higher than that of the second semiconductor layer 102. Also, the activation energy of the third semiconductor layer 103 is higher than that of the second semiconductor layer 102.

Each of layers 101, 102, 103, and 104 in the photosensitive layer 10B comprises a non-single crystal inorganic semiconductor material. Alternatively, each the layers 101, 102, 103, and 104 may comprises a non-single crystal organic semiconductor material. The non-single-crystal material mentioned herein may contain a polycrystalline, microcrystalline or amorphous portion. In this embodiment, the semiconductor layers 101, 102, and 103 include a Si-based amorphous material, and the surface layer 104 include a Si-based amorphous material or a carbon-based amorphous material. The non-single-crystal material layers can be formed by a known deposition technique, such as CVD. The materials of each layer of the photosensitive layer 10B include a-Si-based materials, an a-Se-based materials, such as a-Se, Se—Te and As₂Se₃, compounds containing a Group 12 element and a Group 16 element, such as ZnO, CdS and CdSe, and materials containing these materials dispersed in a resin, and OPC (organic photoconductor)-based photosensitive materials. Among those, preferred are a-Si-based materials, a-Si-based alloys prepared by adding C, N or O to a-Si-based materials, from the viewpoint of desired electrophotographic characteristics, such as high photosensitivity, high responsivity, stable repeatability and high durability, and compatibility with the surface layer 104 that may be formed of hydrogenated amorphous silicon carbide (a-SiC:H). Exemplary a-Si-based materials include a-Si, a-SiC, a-SiN, a-SiO, a-SiGe, a-SiCN, a-SiNO, a-SiCO and a-SiCNO.

The first semiconductor layer 101 includes a silicon-based non-single-crystal material and contains an element of Group 13 in the Periodic Table (hereinafter referred to Group 13 element). The first semiconductor layer 101 is of p-type. The Group 13 element contained in the first semiconductor layer 101 may be substantially uniformly distributed in the first semiconductor layer 101, or the first semiconductor layer 101 may have a portion in which the Group 13 element is non-uniformly distributed in the thickness direction. If the Group 13 element is distributed in the first semiconductor layer 101 such that the end region close to the substrate 10A contains the Group 13 element at a lower concentration than the end region close to the second semiconductor layer 102, the adhesion between the first semiconductor layer 101 and the substrate 10A can be relatively enhanced. Preferably, in any case, the Group 13 element is distributed substantially uniformly in the in-plane direction parallel to the surface of the substrate 10A from the viewpoint of enhancing the uniformity of the characteristics in the in-plane direction.

The atomic concentration of the Group 13 element in the first semiconductor layer 101 is in the range of 5×10¹⁶ to 3×10¹⁸ atoms/cm³. If the atomic concentration of the Group 13 element in the first semiconductor layer 101 is 5×10¹⁶ atoms/cm³ or more, the difference in activation energy (difference between bands) between the first semiconductor layer 101 and the second semiconductor layer 102 can be increased. Accordingly, electrons moving from the substrate 10A to the photosensitive layer can be relatively favorably blocked at the boundary between the first semiconductor layer 101 and the second semiconductor layer 102 when, for example, a positive charge is applied to the surface of the photosensitive layer 10B. The photoreceptor 10 of the present embodiment can reduce leakage current generated by applying a positive charge to the surface of the photosensitive layer. If the atomic concentration of the Group 13 element in the first semiconductor layer 101 is 3×10¹⁸ atoms/cm³ or less, holes can relatively easily move from the first semiconductor layer 101 to the substrate 10A, and the residual potential after neutralization with the charge eliminating device 17 can be kept relatively low (for example, at 20 V or less).

The first semiconductor layer 101 has a thickness in the range of 0.1 to 10 μm from the viewpoint of desired electrophotographic characteristics and cost efficiency. A first semiconductor layer 101 having a thickness of 0.1 μm or more can relatively favorably block electrons moving from the substrate 10A to the photosensitive layer 10B at the boundary between the first semiconductor layer 101 and the second semiconductor layer 102. A first semiconductor layer 101 having a thickness of 10 μm or less allows positive charge to easily enter the substrate 10A from the second semiconductor layer 102 and, thus, can reduce the residual potential after neutralization with the charge eliminating device 17.

The second semiconductor layer 102 receives exposing light emitted from the exposing device 12 according to the image signal and generates carriers therein.

The photoreceptor 10 of the present embodiment is negatively charged and generates, in the second semiconductor layer 102, photocarriers including electrons and holes by exposure. Most of the electrons have a higher mobility than holes. Many of the photocarriers are generated at the surface layer side of the second semiconductor layer 102. Holes having lower mobility than electrons reach the negatively charged surface layer 104 in a relatively short time. Electrons acting as principal photocarriers have high mobility and moves toward the substrate side in the photosensitive layer in a short time. In the photoreceptor 10 of the present embodiment, the photosensitive layer has a relatively low residual potential.

The second semiconductor layer 102 includes a silicon-based non-single-crystal material. A second semiconductor layer 102 containing microcrystalline silicon can have design flexibility, and accordingly can be designed so as to have a high dark conductivity and a high photoconductivity. Microcrystalline silicon can be formed by, for example, CVD performed under appropriately selected conditions. For example, a glow discharge decomposition method can be applied under the conditions in which the temperature of the substrate 10A and the pulsed DC power are set higher and the flow rate of dilution gas (for example, hydrogen) is increased.

Preferably, the second semiconductor layer 102 contains at least one of hydrogen and halogens from the viewpoint of compensating the uncombined hand of silicon. The total content of hydrogen and halogens in the second semiconductor layer 102 is preferably in the range of 1 to 40 at % relative to the total content of silicon, hydrogen and halogens. In order to introduce silicon to the second semiconductor layer 102, hydrogenated silicon compounds (silanes), such as SiH₄, Si₂H₆, Si₃H₈, and Si₄H₁₀, can be used as a raw material of the second semiconductor layer, and SiH₄ and Si₂H₆ are particularly preferable from the viewpoint of silicon supply efficiency or easy handling. In order to introduce an halogen to the second semiconductor layer 102, F₂, BrF, ClF, ClF₃, BrF₃, BrF₅, IF₃, IF₇, SiF₄, Si₂F₆ and so forth may be used as a raw material. The raw material for introducing silicon to the second semiconductor layer 102 may be diluted with at least either H₂ or He if necessary.

The hydrogen or halogen content in the second semiconductor layer 102 can be controlled by adjusting conditions for forming the layer, such as the temperature of the substrate 10A, the amount of the raw material for introducing the element to the second semiconductor layer 102 and the discharge power.

The second semiconductor layer 102 may contain an element for controlling the conductivity. Exemplary conductivity controlling elements include Group 13 elements imparting p-type conductivity and Group 15 elements imparting n-type conductivity. Preferred are boron of the Group 13 elements and phosphorus of the Group 15 elements from the viewpoint of the sensitivity to the semiconductor type or the photosensitivity.

The second semiconductor layer 102 having controlled conductivity may be of n-type, i-type or p-type. In any case, the second semiconductor layer 102 used in the present embodiment has a lower hole density than the first semiconductor layer 101 and the third semiconductor layer 103. Hence, the activation energy of the first semiconductor layer 101 is higher than that of the second semiconductor layer 102, and the activation energy of the third semiconductor layer 103 is higher than that of the second semiconductor layer 102. Therefore, when a negative charge is applied to the surface of the photosensitive layer 10B, electrons are less likely to move from the third semiconductor layer 103 to the first semiconductor layer 101. Also when a positive charge is applied to the surface of the photosensitive layer 10B, electrons are less likely to move from the first semiconductor layer 101 to the third semiconductor layer 103.

Preferably, the second semiconductor layer 102 contains a Group 13 element at an atomic concentration in the range of 2.5×10¹⁴ to 4×10¹⁵ atoms/cm³.

In order to add the conductivity controlling element to the second semiconductor layer 102, a raw material for introducing the conductivity controlling element is added into a reaction chamber together with the raw material for introducing the principal elements of the second semiconductor layer 102. The raw material for introducing the conductivity controlling element may be diluted with at least either H₂ or He if necessary. The concentration of the conductivity controlling element in the second semiconductor layer 102 may be varied in the thickness direction by varying its content in the raw material with time, or varying the dilution ratio of the raw material. In this instance, the content of the conductivity controlling element in the second semiconductor layer 102 is controlled so that the average content in the second semiconductor layer 102 can be in a predetermined range.

The second semiconductor layer 102 may further contain at least one of carbon, oxygen and nitrogen. The total content of carbon, oxygen and nitrogen in the second semiconductor layer 102 is preferably in the range of 1×10⁻⁵ to 10 at % relative to the total content of these elements and silicon.

The second semiconductor layer 102 has a thickness in the range of 5 to 100 μm, preferably in the range of 10 to 80 μm, from the viewpoint of desired electrophotographic characteristics and cost efficiency. A second semiconductor layer 102 having a thickness of 5 μm or more can have high ability of being charged or high photosensitivity. Also, a second semiconductor layer 102 having a thickness of 100 μm or less can be formed in a relatively short time and, thus, the manufacturing cost can be reduced.

The third semiconductor layer 103 blocks the charge at the surface of the photosensitive layer 10B applied by the charger 11 from being injected into the second semiconductor layer 102. The third semiconductor layer 103 used in the present embodiment includes a non-single-crystal material mainly containing at least one of silicon and carbon.

The carbon content in the third semiconductor layer 103 is in the range of 10 to 70 at % relative to the total content of silicon and carbon, and is preferably lower than that in the surface layer 104. A third semiconductor layer 103 containing 10 at % or more of carbon can block the charge at the surface of the photosensitive layer 10B from being injected into the second semiconductor layer 102 more effectively. Also, a third semiconductor layer 103 containing 70 at % or less of carbon has a relatively high electric resistance and can more reduce EV flow of the charge in the third semiconductor layer 103. The EV flow refers to a phenomenon in which a large amount of photocarriers are generated by high-intensity exposure and flow to a portion through which the photocarriers can move easily, thereby blurring electrostatic latent images. Also, a third semiconductor layer 103 having a lower carbon content than the surface layer 104 can reduce the stay of the charge at the interface between the third semiconductor layer 103 and the surface layer 104, and thus can reduce the residual potential.

The third semiconductor layer 103 contains a Group 13 element. The third semiconductor layer 101 is of p-type semiconductor. The Group 13 element may be substantially uniformly distributed in the third semiconductor layer 103, or the third semiconductor layer 103 may have a portion in which the Group 13 element is non-uniformly distributed in the thickness direction. Preferably, the Group 13 element is uniformly distributed from the viewpoint of blocking the charge injection. In either case, it is preferable that the Group 13 element be substantially uniformly distributed in the in-plane direction parallel to the surface of the substrate 10A from the viewpoint of enhancing the uniformity of the characteristics in the in-plane direction.

The atomic concentration of the Group 13 element in the third semiconductor layer 103 is in the range of 5×10¹⁷ to 5×10¹⁹ atoms/cm³. A third semiconductor layer 103 containing 5×10¹⁷ atoms/cm³ or more of Group 13 element can block the injection of the charge at the surface of the photosensitive layer 10B more effectively. In contrast, a third semiconductor layer 103 containing 5×10¹⁹ atoms/cm³ or less of Group 13 element has a relatively low residual charge and, accordingly, can exhibit favorable memory characteristics.

The third semiconductor layer 103 has a thickness in the range of 0.01 to 1 μm from the viewpoint of the ability of blocking the charge injection and the electrophotographic characteristics, such as image quality. A third semiconductor layer 103 having a thickness of 0.1 μm or more can block the injection of the charge at the surface of the photosensitive layer 10B more effectively. A third semiconductor layer 103 has a thickness of 1 μm or less has a relatively low residual charge and, accordingly, can exhibit favorable memory characteristics.

Examples of the Group 13 element contained in the first and the third semiconductor layer include boron (B), aluminum (Al), gallium (Ga), indium (In) and thallium (Tl), and boron is particularly suitable from the viewpoint of easily controlling the concentration of dopant for CVD.

Examples of the raw material for introducing a Group 13 element to the first semiconductor layer and the third semiconductor layer 103 include hydrogenated boron compounds such as B₂H₆, B₄H₁₀, B₅H₉, B₅H₁₁, B₆H₁₀, B₆H₁₂ and B₆H₁₄; boron halides such as BF₃, BCl₃ and BBr₃; and AlCl₃, GaCl₃, Ga(CH₃)₃, InCl₃ and TlCl₃. The raw material for introducing the Group 13 element may be diluted with a gas such as H₂, He, Ar or Ne if necessary.

In order to introduce a Group 13 element to the first semiconductor layer or the third semiconductor layer 103, a raw material for introducing a Group 13 element is added into a reaction chamber together with the raw material for introducing the principal elements of the first semiconductor layer 101 or the third semiconductor layer 103.

The first semiconductor layer 101 and the third semiconductor layer 103 may contain at least one element of nitrogen, oxygen and carbon. The nitrogen, oxygen or carbon contained in the third semiconductor layer 103 may be substantially uniformly distributed in the third semiconductor layer 103, or the third semiconductor layer 103 may have a portion in which such an element is non-uniformly distributed in the thickness direction. In either case, it is preferable that nitrogen, oxygen or carbon be substantially uniformly distributed in the in-plane direction parallel to the surface of the substrate 10A from the viewpoint of enhancing the uniformity of the characteristics in the in-plane direction. If the nitrogen, oxygen or carbon content in the third semiconductor layer 103 is non-uniformly distributed, however, it is preferable that such an element be added such that the region close to the substrate 10A contains the element at a higher concentration than the other region, from the viewpoint of reducing the occurrence of residual charge.

Preferably, the total content of nitrogen, oxygen and carbon in the third semiconductor layer 103 is in the rage of 10 to 70 at % relative to the total content of these elements and silicon.

The surface layer 104 is mainly intended to enhance the moisture resistant, repeatability, voltage endurance, characteristics under working conditions and durability of the electrophotographic photoreceptor 10, and includes a non-single-crystal material mainly containing at least one of silicon and carbon.

The surface layer 104 may include amorphous silicon carbide (a-SiC). In this instance, the carbon content in the a-SiC is preferably in the range of 40 to 90 at % relative to the total content of silicon and carbon. Alternatively, the surface layer 102 may include hydrogenated amorphous silicon carbide (a-SiC:H). In this instance, the carbon content in the a-SiC:H is preferably in the range of 55 to 93 at % (more preferably 60 to 70 at %) relative to the total content of silicon and carbon.

Preferably, the surface layer 104 contains at least one of hydrogen and halogens from the viewpoint of compensating the uncombined hand of silicon. The hydrogen content in the surface layer 104 is preferably in the range of 1 to 70 at % (more preferably 1 to 45 at %) relative to the total of the constituent elements. A hydrogen content of 1 at % or more in the surface layer 104 can sufficiently produce the effect of adding hydrogen. A surface layer 104 containing 70 at % or less of hydrogen can relatively favorably reduce the charge trap caused by irradiating the surface of the surface layer. In this instance, the occurrence of a defective image resulting from the residual potential can be reduced sufficiently.

The surface layer 104 has a thickness in the range of 0.2 to 1.5 μm, and preferably in the range of 0.5 to 1 μm, from the viewpoint of the durability or the residual potential. A surface layer 104 having a thickness of 0.2 μm or more can sufficiently reduce the resulting image having a flaw due to the plate life or a nonuniform density. In contrast, a surface layer 104 having a thickness of 1.5 μm or less can relatively favorably reduce a defective image resulting from residual potential.

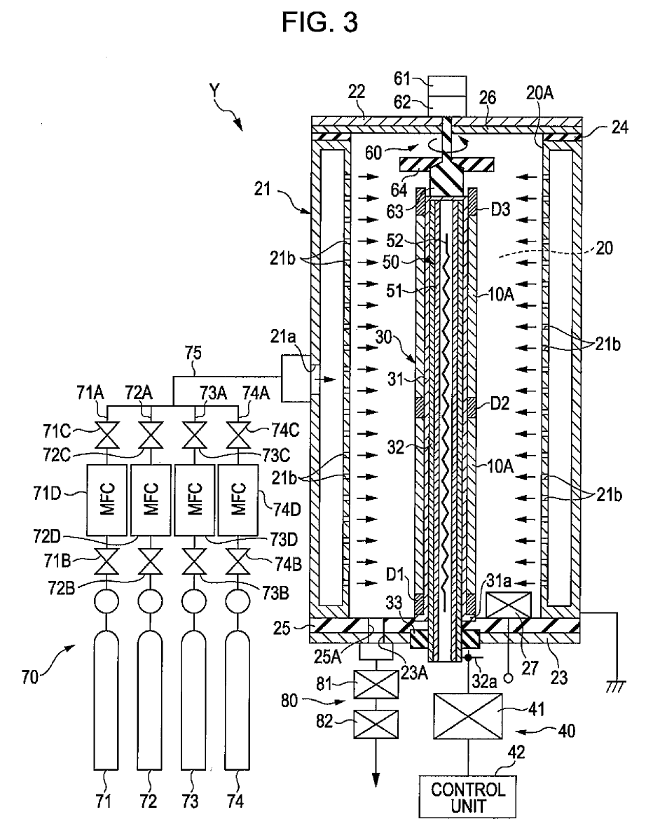

FIG. 3 is a schematic block diagram of a plasma CVD apparatus Y used for forming the first semiconductor layer 101, the second semiconductor layer 102, the third semiconductor layer 103 and the surface layer 104 of the electrophotographic photoreceptor 1.

The plasma CVD apparatus Y includes a reaction chamber 20, a support mechanism 30, a DC voltage supply mechanism 40, a temperature control mechanism 50, a rotation mechanism 60, a gas supply mechanism 70 and an exhaust mechanism 80.

The reaction chamber 20 provides an apace in which deposition layers can be formed on the substrate 10A, and includes a cylindrical electrode 21, a pair of plates 22 and 23 and insulating members 24 and 25.

The cylindrical electrode 21 has a gas inlet 21a and a plurality of gas discharge holes 21b and is grounded at an end thereof. The cylindrical electrode 21 may not be necessarily grounded and, alternatively, may be connected to a reference power supply other than the below-described DC power supply. If the cylindrical electrode 21 is connected to a reference power supply, the reference voltage of the reference power supply is set in the range of, for example, 150 to 1500 V.

The gas inlet 21a is an opening through which a cleaning gas and raw material gases are introduced to the reaction chamber 2, and is connected to a gas supply mechanism 70.

The plate 22 is configured so that the state of the reaction chamber 20, open or closed, can be selected. By opening or closing the plate 22, a below-described support 31 can be taken in or out of the reaction chamber 20.

The plate 23 is intended for a base of the reaction chamber 20, and includes an electroconductive material as the substrate 10A is. The insulating member 25 is disposed between the plate 23 and the cylindrical electrode 21 to reduce the occurrence of an arc discharge between the cylindrical electrode 21 and the plate 23. The insulating member 25 may include any insulating material as long as it is heat-resistant at working temperatures and does not release gas much in a vacuum. Such insulating materials include glasses, such as borosilicate glass, soda glass and heat-resistant glass, inorganic insulating materials, such as ceramic, quartz and sapphire, and insulating synthetic resins, such as fluorocarbon polymers including Teflon (registered trademark), polycarbonate, polyethylene terephthalate including Mylar (registered trademark), polyester, polyethylene, polypropylene, polystyrene, polyamide, vinylon, epoxy and PEEK (polyetheretherketone).

The plate 23 and the insulating member 25 have gas exhaust holes 23A and 25A respectively, and a pressure gauge 27. The gas in the reaction chamber 20 is discharged through the gas exhaust holes 23A and 25A. The gas exhaust holes 23A and 25A are connected to the exhaust mechanism 80. The pressure gauge 27 monitors the pressure in the reaction chamber 20. Any type of known pressure gauges can be used as the pressure gauge 27.

The support mechanism 30 supports the substrate 10A and also serves as a first conductor. The support mechanism 30 includes a support 31, an electroconductive post 32 and an insulating material 33. The support mechanism 30 used in the present embodiment has such a length as can support two substrates 10A, and the support 31 is removable from the electroconductive post 32. This structure allows the two substrates 10A to be placed in and taken out of the reaction chamber 20 without direct contact with the surface of the substrates 10A.

The support 31 is a hollow member having a flange 31a and includes the same electroconductive material as the substrate 10A, and thus the entirety thereof functions as a conductor.

The electroconductive post 32 is a tube having a conductor plate 32a and includes the same electroconductive material as the substrate 10A, and thus the entirety thereof functions as a conductor. The electroconductive post 32 is in contact with the inner wall of the support 31 at the upper end thereof.

The DC voltage supply mechanism 40 supplies a DC voltage to the electroconductive post 32 and includes a DC power supply 41 and a control unit 42. The DC power supply 41 generates a DC voltage to be applied to the electroconductive post 32 and is connected to the electroconductive post 32 with the conductor plate 32a.

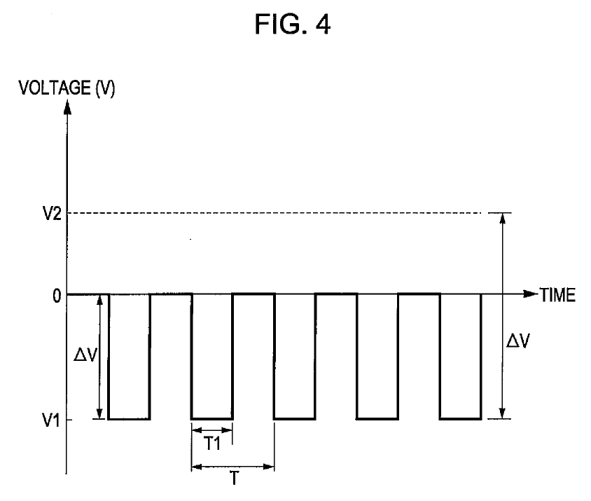

The control unit 42 controls the operation of the DC power supply 41 and is connected to the DC power supply 41. The control unit 42 controls the DC power supply 41 so that a pulsed DC voltage (see FIG. 4) can be applied to the support 31 through the electroconductive post 32.

The temperature control mechanism 50 controls the temperature of the substrates 10A, and includes a ceramic pipe 51 and a heater 52.

The heater 52 heats the substrates 10A and is housed inside the electroconductive post 32. The temperature of the substrates 10A is controlled by controlling the on/off state of the heater 52 according to the monitoring result of a thermocouple (not shown) put on, for example, the support 31 or the electroconductive post 32. The substrates 10A are kept at a predetermined temperature in the range of, for example, 200 to 400° C. The heater 52 may be a Nichrome wire or a cartridge heater.

The rotation mechanism 60 rotates the support 31 and includes a rotation motor 61, a rotation driving terminal 62, an insulating shaft 63 and an insulating plate 64. For deposition, the rotation mechanism 60 rotates the support mechanism 30 so that the substrates 10A can be rotated together with the support 31. This is advantageous in depositing decomposed components of the raw material gases substantially uniformly on the peripheries of the substrates 10A.

The gas supply mechanism 70 includes a plurality of raw material gas cylinders 71, 72, 73 and 74, a plurality of pipes 71A, 72A, 73A and 74A, valves 71B, 72B, 73B, 74B, 71C, 72C, 73C and 74C, and a plurality of mass flow controllers 71D, 72D, 73D and 74D, and is connected to the cylindrical electrode 21 through a pipe 75 and the gas inlet 21a.

Each of the raw material gas cylinders 71, 72, 73 and 74 is filled with a raw material gas. The raw material gases include, for example, SiH₄, H₂, B₂H₆, CH₄, N₂ and NO.

The valves 71B, 72B, 73B, 74B, 71C, 72C, 73C and 74C and the mass flow controllers 71D, 72D, 73D and 74D are used for controlling the flow rates and the pressures of the gases introduced to the reaction chamber 20 to adjust the composition of the gas in the reaction chamber 20. The types of gases filing the raw material gas cylinders and the number of gas cylinders of the gas supply mechanism 70 can be appropriately selected according to the type or the composition of the film to be formed on the substrate 10A.

The exhaust mechanism 80 discharges the gas in the reaction chamber 20 to the outside through the gas exhaust holes 23A and 25A and includes a mechanical booster pump 81 and a rotary pump 82. The operations of these pumps 81 and 82 are controlled according to the monitoring result of the pressure gauge 27. More specifically, the exhaust mechanism 80 allows the reaction chamber 20 to be kept in a predetermined vacuum state with a desired gas pressure according to the monitoring result of the pressure gauge 27. The pressure of the reaction chamber 20 is set in the range of, for example, 1.0 to 100 Pa or less.

A deposition method using the plasma CVD apparatus Y will now be described with reference to a case in which the electrophotographic photoreceptor 10 as shown in FIG. 2 is formed.

The substrate 10A is controlled to a predetermined temperature by the temperature control mechanism 50, and the reaction chamber 20 is evacuated by the exhaust mechanism 80. The temperature of the substrate 10A is increased to about a predetermined value by heating the heater 52 and is kept at the predetermined temperature by turning on or off the heater 52. The temperature of the substrate 10A is appropriately set according to the type of the film to be formed on the surface of the substrate 10A. For example, when an a-Si film is formed, the substrate 10A is set at a temperature in the range of 250 to 300° C. The evacuation of the reaction chamber 20 is performed by controlling the operations of the mechanical booster pump 81 and the rotary pump 82 so as to discharge the gas from the reaction chamber 20 through the gas exhaust holes 23A and 25A while the pressure of the reaction chamber 20 is monitored with the pressure gauge 27. The reaction chamber 20 is evacuated to a pressure of, for example, about 1×10⁻³ Pa.

Subsequently, the gas supply mechanism 70 supplies raw material gases to the reaction chamber 20 with the substrate 10A kept at a predetermined temperature and the reaction chamber 20 evacuated to a predetermined pressure, and a pulsed DC voltage is applied between the cylindrical electrode 21 and the support 31. Thus, glow discharge occurs between the cylindrical electrode 21 and the support 31 (substrate 10A) to decompose the raw material gases, and the decomposed components are deposited on the surface of the substrate 10A. The exhaust mechanism 80 controls the operations of the mechanical booster pump 81 and the rotary pump 82 while monitoring the pressure gauge 27, thereby keeping the reaction chamber 20 at a pressure in a predetermined range (for example, 1.0 to 100 Pa) More specifically, the interior of the reaction chamber 20 is kept at a pressure in a predetermined range with the mass flow controllers 71D, 72D, 73D and 74D of the gas supply mechanism 70 and the pumps 81 and 82 of the exhaust mechanism 80. The raw material gases are supplied to the reaction chamber 20 by controlling the mass flow controllers 71D, 72D, 73D and 74D and appropriately controlling the open/closed states of the valves 71B, 72B, 73B, 74B, 71C, 72C, 73C and 74C so that a gas having a predetermined composition is introduced to the interior of the cylindrical electrode 21 at a predetermined flow rate through the pipes 71A, 72A, 73A, 74A and 75 and the gas inlet 21a. The mixture of the raw material gases introduced to the cylindrical electrode 21 is discharged to the substrate 10A through the gas discharge holes 21b. The composition of the gas mixture is varied as desired by adjusting the valves 71B, 72B, 73B, 74B, 71C, 72C, 73C and 74C and the mass flow controllers 71D, 72D, 73D and 74D. For applying a pulsed DC voltage between the cylindrical electrode 21 and the support 31, if the cylindrical electrode 21 is grounded, a negative pulsed DC voltage V1 (see FIG. 4) in the range of −3000 to −50 V (preferably −3000 to −500 V) is applied. If the cylindrical electrode 21 is connected to a reference power supply (not shown), a pulsed voltage is applied so that the difference in voltage ΔV from the reference voltage V2 supplied from the reference power supply comes to a desired value (for example, −3000 to −50 V). If a negative pulsed voltage (see FIG. 4) is applied to the support 31 (substrate 10A), the voltage V2 supplied from the reference power supply is set in the range of, for example, 1500 to 1500 V. The control unit 42 controls the DC power supply 41 so that the DC voltage has a frequency (1/T (s)) of 300 kHz or less and a duty ratio (T1/T) in the range of 20% to 90%. The duty ratio mentioned herein refers to the ratio of the time period T1 for which a potential difference occurs to the cycle T of pulses of the DC voltage (time period between the moment at which a potential difference arises between the substrate 10A and the cylindrical electrode 21 and the moment at which the next potential difference arises) as shown in FIG. 4. For example, a duty ratio of 20% means that the time period for which a potential difference occurs is 20% of the entire time period of a cycle in which a pulsed voltage is applied. Thus, a first semiconductor layer 101, a second semiconductor layer 102, a third semiconductor layer 103 and a surface layer 104 are deposited in that order on the surface of the substrate 10A.

In the electrophotographic photoreceptor 10 of the present embodiment, the first semiconductor layer 101 and the third semiconductor layer 103 include a p-type semiconductor, and the second semiconductor layer 102 has a smaller hole density than the first semiconductor layer 101 and the third semiconductor layer 103. Accordingly, the photoreceptor of the present embodiment does not allow electrons to move from the surface of the substrate toward the surface of the photosensitive layer through the photosensitive layer even if a positive charge is applied to the surface of the photoreceptor for transfer. In the photoreceptor of the present embodiment, leakage current can be reduced even if a relatively high positive charge is applied to the surface of the photoreceptor. The electrophotographic photoreceptor 10 of the present embodiment is advantageous in increasing the withstand voltage against positive charge. The photoreceptor 10 of the present embodiment is negatively charged and generates photocarriers in the second semiconductor layer 102 by exposure. Most of the photocarriers have a higher mobility than holes. In the photoreceptor 10 of the present embodiment, the photosensitive layer has a relatively low residual potential.

If boron is used as the Group 13 element for the electrophotographic photoreceptor 10, a p-type barrier can be appropriately formed in the first semiconductor layer 101. Since hydrogenated boron compounds, such as B₂H₆, are in gaseous form at room temperature, the dopant concentration for CDV deposition can be controlled more easily than in use of, for example, gallium, aluminum or indium.

If the concentration of the Group 13 element is varied in the first semiconductor layer 101 such that the end region closer to the substrate 10A contains the Group 13 element at a lower concentration than the end region closer to the second semiconductor layer 102, the adhesion of the first semiconductor layer 101 can be enhanced.

An image forming apparatus X according to an embodiment includes the electrophotographic photoreceptor 10 of an embodiment of the present invention. Therefore, the advantages of the electrophotographic photoreceptor 10 can be produced in the image forming apparatus. More specifically, the image forming apparatus X can reduce afterimages resulting from the residual potential and can reduce the occurrence of leakage current (increase the withstand voltage against positive charge) during transfer. The image forming apparatus X of the present embodiment can reliably form high-quality images having few defectives resulting from afterimages and leakage current. The image forming apparatus X of the present embodiment can be suitably used for forming many images in a short time by rotating a photoreceptor at a relatively high speed. For example, defective images, such as so-called ghost, can be reduced even if the photoreceptor is rotated at a high speed, because the residual potential of the photoreceptor can be reduced in a shorter time. In addition, the toner image on the surface of the photoreceptor can be reliably transferred in a relatively short time. Accordingly, even if the positive charge for transfer is increased, defective images resulting from leakage current can be reduced.

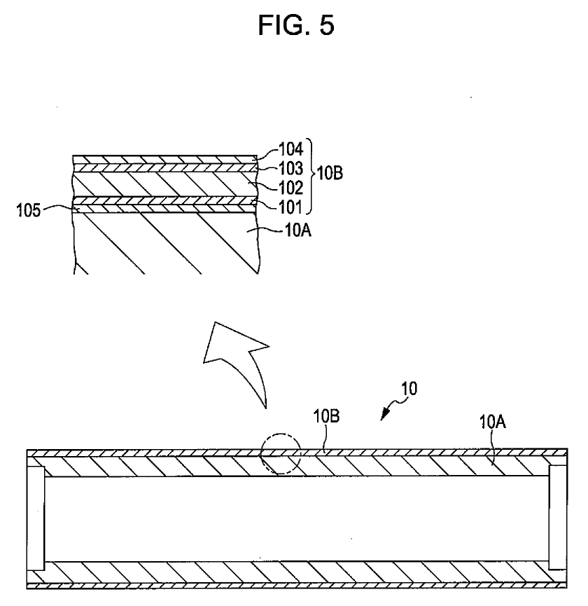

For example, as shown in FIG. 5, the electrophotographic photoreceptor 10 may include a silicate layer 105 between the substrate 10A and the first semiconductor layer 101. The silicate layer 105 mainly contains the main constituent of the substrate 10A (for example, aluminum), silicon and oxygen. Preferably, the thickness of the silicate layer 105 is 0.5 nm or more from the viewpoint of sufficiently producing the effect thereof, and is 15 nm or less from the viewpoint of ensuring that the substrate 10A has a sufficient conductivity. The silicate layer 105 may be formed by immersing the substrate 10A mainly containing, for example, aluminum in a silicate-containing aqueous solution. Exemplary silicates include potassium silicate and sodium silicate. The silicate content in the silicate-containing solution is preferably in the range of 1% to 2% by mass from the viewpoint of reducing the occurrence of silicate damage. The silicate layer 105 disposed between the substrate 10A and the first semiconductor layer 101 increases the voltage at which leakage current starts to occur, thus increasing the withstand voltage.

### EXAMPLES

### <Production of Electrophotographic Photoreceptor>

For producing an electrophotographic photoreceptor, an aluminum alloy pipe (outer diameter: 84 mm, length: 360 mm) was used as the cylindrical substrate. A photosensitive layer including a lower charge injection blocking layer, a photoconductive layer, an upper charge injection blocking layer, and a surface layer was formed on the aluminum pipe under the conditions shown in Table 1 by a known plasma CVD. The B₂H₆ flow rate shown in Table 1 represents the ratio relative to the SiH₄ flow rate. A pulsed DC power supply (pulse frequency: 50 kHz, Duty ratio: 70%) was used as the power supply for the plasma CVD apparatus. Thicknesses were measured by analyzing sections by SEM and XMA.

TABLE 1

| | | layers | | | |
|---|---|---|---|---|---|
| | | | | Upper | |
| | | | | charge | |
| | | Lower charge | Photo- | injection | |
| | | injection | conductive | blocking | Surface |
| | | blocking layer | layer | layer | layer |
| | | (101) | (102) | (103) | (104) |
| Gases | SiH₄ (sccm) | 170 | 340 | 340 | 10 |
| | H₂ (sccm) | 200 | 200 | 200 | 0 |
| | B₂H₆ (ppm) | 0-10000 | 0 | 3000 | 0 |
| | CH₄ (sccm) | 0 | 0 | 0 | 1000 |
| | NO (sccm) | 17 | 0 | 100 | 0 |

| | | | | |
|---|---|---|---|---|
| Pressure (Pa) | 80 | 80 | 80 | 86.5 |
| Substrate | 300 | 320 | 320 | 250 |
| Temperature (° C.) | | | | |
| DC voltage (V) | −665 | −735 | −735 | −280 |
| Pulse frequency | 50 | 50 | 50 | 50 |
| (kHz) | | | | |
| Duty ratio (%) | 70 | 70 | 70 | 70 |
| Thickness (μm) | 5 | 20 | 0.5 | 1 |

### <Measurement of Group 13 Element Atomic Concentration>

Test samples were irradiated with O₂⁺ ions at an acceleration voltage of 8.0 keV, and the secondary ions emitted from the test samples were measured by mass spectrometry using a secondary ion mass spectrometer (model: PHI ADEPT-1010, manufactured by Ulvac-Phi, Inc.). Each test sample was prepared by forming only a lower charge injection blocking layer on an aluminum alloy pipe (outer diameter: 84 mm, length: 360 mm) using a plasma CVD apparatus as shown in FIG. 3 under conditions shown in Table 1. The resulting samples thus prepared are considered to be substantially the same as the electrophotographic photoreceptor from which the layers (photoconductive layer, upper charge injection blocking layer and surface layer) overlying the lower charge injection blocking layer have been removed.

TABLE 2

| | Group 13 element | | |
|---|---|---|---|
| | atomic | | |
| | concentration | | |
| | in lower charge | Withstand | Residual |
| | injection blocking | voltage* | potential |
| | layer (cm⁻³) | (normalized) | (V) |
| Experimental Example 1 | 0 | 1 | 9 |
| Experimental Example 2 | 4 × 10¹⁶ | 1.2 | 10 |
| Experimental Example 3 | 5 × 10¹⁶ | 1.6 | 11 |
| Experimental Example 4 | 2.5 × 10¹⁷ | 1.7 | 11 |
| Experimental Example 5 | 5 × 10¹⁷ | 1.8 | 12 |
| Experimental Example 6 | 1 × 10¹⁸ | 1.9 | 13 |
| Experimental Example 7 | 2.5 × 10¹⁸ | 2 | 14 |
| Experimental Example 8 | 3 × 10¹⁸ | 2 | 18 |
| Experimental Example 9 | 4 × 10¹⁸ | 2.1 | 25 |
| Experimental Example | 5 × 10¹⁸ | 2.2 | 50 |
| 10 | | | |

*Withstand voltage (normalized) is a value normalized with the withstand voltage when the atomic concentration of Group 13 element is 0.

### <Measurement of Withstand Voltage>

A predetermined voltage (for example, 1 to 2.2 kV) was applied with the probe of a high voltage generator (Model 610C, manufactured by Trek Japan Corporation) in contact with the uppermost layer of the electrophotographic photoreceptor sample, and the leakage current at this time was measured. The applied voltage at the time when the leakage current came to a specified value (2 mA) was defined as withstand voltage. The results are shown in Table 2.

### <Measurement of Residual Potential (Surface Potential)>

The electrophotographic photoreceptor sample was mounted on an image forming apparatus (model: KM-8030, manufactured by Kyocera Mita Corporation). A charge of 0.3 μC/cm² was applied to the surface of the electrophotographic photoreceptor at a negative potential. After the entire surface was irradiated with light having a predetermined wavelength and intensity, the surface potential was measured with a surface potential meter (Model 344, manufactured by Trek Japan Corporation) disposed in the developing region. The results are shown in Table 2.

### <Evaluation>

Each of the electrophotographic photoreceptor samples of Experimental Examples 3 to 8 kept the residual potential at the specified value (20 V) or less, and exhibited a withstand voltage of a specified value (1.5 times as high as the withstand voltage when the atomic concentration of Group 13 element is 0) or more against positive charge. Thus, the electrophotographic photoreceptor samples of Experimental Examples 3 to 8 reduced afterimages and exhibited increased withstand voltages against positive charge.

In the electrophotographic photoreceptor samples of Experimental Examples 1 and 2, on the other hand, the withstand voltage against positive charge was the specified value (1.5 times as high as the withstand voltage when the atomic concentration of the Group 13 element is 0) or less. Thus, the withstand voltage against positive charge was not sufficiently increased. The electrophotographic photoreceptor samples of Experimental Examples 9 and 10 exhibited residual potentials more than the specified value (20 V), and afterimages were not reduced sufficiently. More specifically, the output images were degraded in solid black density and contrast.

### Another Embodiment

A photoreceptor according to another embodiment of the invention is described. In a photoreceptor according to an embodiment, the second semiconductor layer may contain a Group 13 element at an atomic concentration in the range of 2.5×10¹⁴ to 4×10¹⁵ atoms/cm³. Such a electrophotographic photoreceptor can keep the residual potential at a specified value (20 V) or less, and exhibit a withstand voltage of a specified value (for example, 1.5 times as high as the withstand voltage when the atomic concentration of the Group 13 element is 0) or more against positive charge. Thus, the photoreceptor of the present embodiment can advantageously reduce afterimages and exhibit an increased withstand voltage against positive charge. In the photoreceptor of the present embodiment, the first semiconductor layer does not necessarily contain a Group 13 element.

If boron is used as the Group 13 element for the photoreceptor, it becomes possible to reduce the distortion of the lattice resulting from the difference in diameter between the Group 13 element and silicon, which principally constitutes the non-single-crystal material of the second semiconductor layer. In addition, hydrogenated boron compounds, such as B₂H₆, are in gaseous form at room temperature. Accordingly, the dopant concentration for forming a film by CVD can be controlled more easily than in use of, for example, gallium, aluminum or indium.

### Examples

### <Production of Electrophotographic Photoreceptor>

For producing an electrophotographic photoreceptor, an aluminum alloy pipe (outer diameter: 84 mm, length: 360 mm) was used as the cylindrical substrate. A photosensitive layer including a lower charge injection blocking layer, a photoconductive layer, an upper charge injection blocking layer, and a surface layer was formed on the aluminum pipe under the conditions shown in Table 3 by a known plasma CVD. The B₂H₆ flow rate shown in Table 3 represents the ratio relative to the SiH₄ flow rate. A pulsed DC power supply (pulse frequency: 50 kHz, Duty ratio: 70%) was used as the power supply for the plasma CVD apparatus. Thicknesses were measured by analyzing sections by SEM and XMA.

TABLE 3

| | | Layers | | | |
|---|---|---|---|---|---|
| | | | | Upper | |
| | | | | charge | |
| | | Lower charge | Photo- | injection | |
| | | injection | conductive | blocking | Surface |
| | | blocking layer | layer | layer | layer |
| | | (101) | (102) | (103) | (104) |
| Gases | SiH₄ (sccm) | 170 | 340 | 340 | 10 |
| | H₂ (sccm) | 200 | 200 | 200 | 0 |
| | B₂H₆ (ppm) | 0 | 0-0.1 | 3000 | 0 |
| | CH₄ (sccm) | 0 | 0 | 0 | 1000 |
| | NO (sccm) | 17 | 0 | 100 | 0 |

| | | | | |
|---|---|---|---|---|
| Pressure (Pa) | 80 | 80 | 80 | 86.5 |
| Substrate | 300 | 320 | 320 | 250 |
| Temperature (° C.) | | | | |
| DC voltage (V) | −665 | −735 | −735 | −280 |
| Pulse frequency | 50 | 50 | 50 | 50 |
| (kHz) | | | | |
| Duty ratio (%) | 70 | 70 | 70 | 70 |
| Thickness (μm) | 5 | 20 | 0.5 | 1 |

### <Measurement of Group 13 Element Atomic Concentration>

Test samples were irradiated with O₂⁺ ions at an acceleration voltage of 8.0 keV, and the secondary ions emitted from the test samples were measured by mass spectrometry using a secondary ion mass spectrometer (model: PHI ADEPT-1010, manufactured by Ulvac-Phi, Inc.). Each test sample was prepared by forming only a lower charge injection blocking layer on an aluminum alloy pipe (outer diameter: 84 mm, length: 360 mm) using a plasma CVD apparatus as shown in FIG. 3 under conditions shown in Table 3. The resulting samples thus prepared are considered to be substantially the same as the electrophotographic photoreceptor from which the layers (photoconductive layer, upper charge injection blocking layer and surface layer) overlying the lower charge injection blocking layer have been removed.

TABLE 4

| | Group 13 | | |
|---|---|---|---|
| | element atomic | | |
| | concentration in | Withstand | Residual |
| | photoconductive | voltage* | potential |
| | layer (cm⁻³) | (normalize) | (V) |
| Experimental Example 1 | 0 | 1 | 9 |
| Experimental Example 2 | 1.5 × 10¹⁴ | 1.1 | 9 |
| Experimental Example 3 | 2.5 × 10¹⁴ | 1.6 | 10 |
| Experimental Example 4 | 5 × 10¹⁴ | 1.6 | 10 |
| Experimental Example 5 | 1 × 10¹⁵ | 1.6 | 11 |
| Experimental Example 6 | 1.5 × 10¹⁵ | 1.6 | 11 |
| Experimental Example 7 | 2 × 10¹⁵ | 1.7 | 12 |
| Experimental Example 8 | 2.5 × 10¹⁵ | 1.7 | 13 |
| Experimental Example 9 | 3 × 10¹⁵ | 1.8 | 14 |
| Experimental Example 10 | 3.5 × 10¹⁵ | 1.8 | 18 |
| Experimental Example 11 | 4 × 10¹⁵ | 1.9 | 19 |
| Experimental Example 12 | 4.5 × 10¹⁵ | 2 | 25 |
| Experimental Example 13 | 5 × 10¹⁵ | 2 | 50 |

*Withstand voltage (normalized) is a value normalized with the withstand voltage when the atomic concentration of Group 13 element is 0.

### <Measurement of Withstand Voltage>

A predetermined voltage (for example, 1 to 2.2 kV) was applied with the probe of a high voltage generator (Model 610C, manufactured by Trek Japan Corporation) in contact with the uppermost layer of the electrophotographic photoreceptor sample, and the leakage current at this time was measured. The applied voltage at the time when the leakage current came to a specified value (2 mA) was defined as withstand voltage. The results are shown in Table 4.

### <Measurement of Residual Potential (Surface Potential)>

The electrophotographic photoreceptor sample was mounted on an image forming apparatus (model: KM-8030, manufactured by Kyocera Mita Corporation). A charge of 0.3 μC/cm² was applied to the surface of the electrophotographic photoreceptor at a negative potential. After the entire surface was irradiated with light having a predetermined wavelength and intensity, the surface potential was measured with a surface potential meter (Model 344, manufactured by Trek Japan Corporation) disposed in the developing region. The results are shown in Table 4.

### <Evaluation>

Each of the electrophotographic photoreceptor samples of Experimental Examples 3 to 11 kept the residual potential at the specified value (20 V) or less, and exhibited a withstand voltage of a specified value (1.5 times as high as the withstand voltage when the atomic concentration of the Group 13 element is 0) or more against positive charge. Thus, the electrophotographic photoreceptor samples of Experimental Examples 3 to 11 reduced afterimages and exhibited increased withstand voltages against positive charge.

In the electrophotographic photoreceptor samples of Experimental Examples 1 and 2, on the other hand, the withstand voltage against positive charge was the specified value (1.5 times as high as the withstand voltage when the atomic concentration of the Group 13 element is 0) or less. Thus, the withstand voltage against positive charge was not sufficiently increased. The electrophotographic photoreceptor samples of Experimental Examples 12 and 13 exhibited residual potentials more than the specified value (20 V), and afterimages were not reduced sufficiently. More specifically, the output images were degraded in solid black density and contrast.

Although the present invention has been fully described in connection with embodiments thereof with reference to the accompanying drawings, it is to be noted that various changes and modifications will become apparent to those skilled in the art. Such changes and modifications are to be understood as being included within the scope of the present invention as defined by the appended claims.

Terms and phrases used in this document, and variations thereof, unless otherwise expressly stated, should be construed as open ended as opposed to limiting. As examples of the foregoing: the term “include” should be read as mean “include, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

1. A photoreceptor comprising:
a conductive substrate;
a first semiconductor layer over the conductive substrate;
a second semiconductor layer over the first semiconductor layer; and
a third semiconductor layer over the second semiconductor layer; wherein
each of the first and the third semiconductor layers comprises a p-type semiconductor, and
the second semiconductor layer has a hole density smaller than the first and the third semiconductor layers.

2. The photoreceptor according to claim 1, wherein the first semiconductor layer has a hole density smaller than the third semiconductor layer.

3. The photoreceptor according to claim 1, wherein the first semiconductor layer comprises a first end region and a second end region closer to the second semiconductor layer than the first region, and the second end region has a hole density smaller than the first end region.

4. The photoreceptor according to claim 1, wherein each of the first and the third semiconductor layers comprises a non-single-crystal material including a silicon as a main component, and
each of the first and the third semiconductor layers further comprises an element of group 13 of periodic table.

5. The photoreceptor according to claim 4, an atom density of the element of group 13 in the first semiconductor layer is smaller than an atom density of the element of group 13 in the third semiconductor layer.

6. The photoreceptor according to claim 5, wherein the atom density of the element of group 13 in the first semiconductor layer is not less than 5×10¹⁶ [1/cm³] and not more than 3×10¹⁸ [1/cm³], and
the atom density of the element of group 13 in the third semiconductor layer is not less than 5×10¹⁷ [1/cm³] and not more than 5×10¹⁹ [1/cm³].

7. The photoreceptor according to 6, wherein the second semiconductor layer further comprises an element of group 13 of periodic table whose atom density is not less than 2.5×10¹⁴ [1/cm³] and not more than 4×10¹⁵ [1/cm³].

8. The photoreceptor according to claim 4, wherein the element of group 13 in the first and the third semiconductor layers includes boron.

9. The photoreceptor according to claim 1, further comprising:
a silicate layer between the conductive substrate and the first semiconductor layer.

10. The photoreceptor according to claim 9, wherein the silicate layer comprises an nitrogen.

11. An image forming apparatus comprising:
the photoreceptor according to claim 1;
a charger for electrically-negatively charging a surface of the photoreceptor;
an exposing device for illuminating the charged surface of the photoreceptor to form an electrostatic latent image on the surface of the photoreceptor;
a developing device for supplying a toner onto the surface of the photoreceptor to form on a toner image corresponding to the electrostatic latent image thereon; and
a transferring device for electrically-positively charging a medium to be supplied to the surface of the electrographic photoreceptor, and transferring the toner image to the medium.
